(19) United States
(12) Patent Application Publication
(10) Pub. No.: US 2026/0120536 A1
(43) Pub. Date: Apr. 30, 2026

(54) SYSTEM AND METHOD FOR MERGING SYMBOLS IN A WAGERING GAME

(71) Applicant: STABLE GAMES LTD., VALLETTA (MT)

(72) Inventors: Aliaksei Baliukonis, Warsaw (PL); Nikolay Alekseevich Rumyantsev, St. Petersburg (RU)

(73) Assignee: STABLE GAMES LTD., VALLETTA (MT)

(21) Appl. No.: 19/364,607

(22) Filed: Oct. 21, 2025

Related U.S. Application Data
(60) Provisional application No. 63/712,321, filed on Oct. 25, 2024.

(51) Int. Cl. G07F 17/32

(52) U.S. Cl. CPC G07F 17/3211; G07F 17/3244

(57) ABSTRACT

A non-transitory computer-readable medium storing instruction that, when executed by a processor, cause the processor to (a) display a symbol field including reels, each reel including cells each containing a symbol displayed therein, each of the symbols having a predefined value assigned thereto; (b) identify a first cluster forming a winning combination, each cell of the first cluster containing a first symbol, and each of the first symbols being a symbol of an identical value; (c) cause the first cluster of cells to merge into a second cluster of cells, each cell of the second cluster containing a second symbol, the second cluster having less cells than the first cluster, and each of the second symbols being one level higher in value than the first symbol; and (d) identify a first vacant cell in the symbol field and lower respective one of the reels to fill the first vacant cell.

### CROSS REFERENCE TO RELATED APPLICATION

This application claims priority to U.S. provisional application Ser. No. 63/712,321, filed Oct. 25, 2024, which is hereby incorporated herein by reference in its entirety.

### FIELD OF THE INVENTION

The present invention relates in general to gaming systems, and more particularly to a gaming system and method for providing winning combinations by merging slot symbols into new slot symbols.

### BACKGROUND OF THE INVENTION

Electronic gaming machines, devices or computer applications provide a variety of wagering games or entertainment gaming such as slot games, video poker games, video blackjack games, roulette games, video bingo games, keno games and other types of games that are frequently offered at casinos, playable on social media websites, or downloadable via mobile computer applications. The word “gaming” may also be used to refer to wagering games and gambling games. Regardless of whether the gaming occurs in a physical, brick-and-mortar casino or a virtual, online casino or online environment, these types of casino or wagering games usually include three components: a wager, chance, and a reward. That is, casino or wagering games are usually games in which the outcome of a wager, which is a reward, is determined by chance. Thus, in wagering games, chance often predominates over every other factor, including skill. For example, chance predominates in card games such as poker, blackjack, or the like, even though some skill is involved. Specifically, chance, rather than the player's skill, determines which cards are dealt to the players, which cards are dealt to a dealer, if any, which cards are cut from the deck or shoe of cards, and so forth. In other wagering games, such as reel slot games, numbers games, dice games, wheel games, or the like, chance is the only factor to determine the outcome of the wagering game, with skill having no influence on the symbols or numbers drawn, rolled, or spun. Playing such games typically involves a player establishing a credit balance by purchasing points or inputting money and placing a monetary wager (from the credit balance) on one or more outcomes of an instance (or single play) of a primary or base game. In many games, a player may qualify for secondary games or bonus rounds by attaining a certain winning combination or triggering event in the base game. Secondary games provide an opportunity to win additional game instances, credits, awards, jackpots, progressives, etc. Awards from any winning outcomes are typically added back to the credit balance and can be provided to the player upon completion of a gaming session or when the player wants to “cash out.”

“Slot” type games or reel slot games are often displayed to the player in the form of various symbols arrayed in a row-by-column grid or matrix. Specific matching combinations of symbols along predetermined paths (or paylines) through the matrix indicate the outcome of the game. The display typically highlights winning combinations/outcomes for ready identification by the player. Matching combinations and their corresponding awards are usually shown in a “pay-table” which is available to the player for reference.

Typical games use a random number generator to randomly determine the outcome of each game. The game is designed to return a certain percentage of the amount wagered back to the player over the course of many plays or instances of the game. The percent wager return and randomness of the random number generator are critical to ensuring the fairness of the games and are therefore highly regulated. Upon initiation of play, the random number generator randomly determines a game outcome and symbols are then selected which correspond to that outcome. Notably, some games may include an element of skill on the part of the player and are therefore not entirely random. While such electronic gaming machines, devices or computer applications are ideally designed to provide players with entertainment, a need exists for new gaming mechanics in order to provide increased payouts to players and enhance player entertainment and enjoyment.

### SUMMARY OF THE INVENTION

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

The disclosure of the present invention provides an online slot-style game that is based on new features (the elements and mechanics that define the gameplay and boost wins) of merging slot symbols for winnings. The game system of the present disclosure aims to improve the gaming and entertainment experience for players of the games of the prior art by providing features that render winnings or payouts for a winning combination in slots without lines and ways. In essence, this is achieved by merging or combining game symbols into new game symbols in a unique way. The innovative features of the game system of the present disclosure provide a novel approach to calculating winnings in slot and gambling systems. Distinguishing itself from conventional features of slot games, the gaming features of the present disclosure introduce a dynamic element in which the combination of symbols not only yields a win but also triggers the creation of new symbols of increased value, potentially leading to further formation of more valuable combinations and increased amounts of winnings. Thus, players are incentivized not only to maximize the number of combinations but also to augment the value of the slot symbols forming the winning combinations.

According to one form of the present invention, a game system for conducting a game including a gaming machine communicatively connected to a game engine, the gaming machine including a user interface (UI) operable by a player, the game engine including a game logic module, a random number generator, and a game flow management layer. The game engine is configured to control the UI to display a symbol field comprising a plurality of reels, each reel including a plurality of cells each containing a symbol displayed therein, each of the symbols having a predefined value or tier assigned thereto. The game engine is also configured to, in response to a first cluster of cells aligning to form a winning combination, identify the winning combination and provide a payout to the player, each cell of the first cluster containing a first symbol, and each of the first symbols being a symbol of an identical value or tier. The game engine is further configured to, in response to the winning combination being identified, cause the first cluster of cells to merge into a second cluster of cells, each cell of the second cluster containing a second symbol, the second cluster having less cells than the first cluster, and each of the second symbols being one level higher in value than the first symbol. The game engine is additionally configured to, in response to the second cluster having less cells than the first cluster, identify a first vacant cell in the symbol field and lower respective one of the reels to fill the first vacant cell with a first cell containing the symbol displayed therein. The game engine is yet configured to detect if a third cluster of cells aligned to form a new winning combination.

According to another form of the present invention, a method of operating a gaming machine includes the step of displaying a symbol field including a plurality of reels, each reel including a plurality of cells each containing a symbol displayed therein, each of the symbols having a predefined value or tier assigned thereto. In response to a first cluster of cells aligning to form a winning combination, the step of identifying the winning combination and providing a payout to the player, each cell of the first cluster containing a first symbol, and each of the first symbols being a symbol of an identical value or tier. In response to the step of identifying the winning combination, the step of causing the first cluster of cells to merge into a second cluster of cells, each cell of the second cluster containing a second symbol, the second cluster having less cells than the first cluster, and each of the second symbols being one level higher in value than the first symbol. In response to the second cluster having less cells than the first cluster, the step of identifying a first vacant cell in the symbol field and lowering respective one of the reels to fill the first vacant cell with a first cell containing the symbol displayed therein, and the step of detecting if a third cluster of cells aligned to form a new winning combination.

According to still another form of the present invention, a non-transitory computer-readable medium storing instruction that, when executed by a processor, cause the processor to control a user interface to display a symbol field including a plurality of reels, each reel including a plurality of cells each containing a symbol displayed therein, wherein each of the symbols has a predefined value or tier assigned thereto. The processor is further caused to, in response to a first cluster of cells aligning to form a winning combination, identify the winning combination and provide a payout to the player, each cell of the first cluster containing a first symbol, and each of the first symbols being a symbol of an identical value or tier. The processor is also caused to, in response to the winning combination being identified, cause the first cluster of cells to merge into a second cluster of cells, each cell of the second cluster containing a second symbol, the second cluster having less cells than the first cluster, and each of the second symbols being one level higher in value than the first symbol. Additionally, the processor is caused to, in response to the second cluster having less cells than the first cluster, identify a first vacant cell in the symbol field and lower respective one of the reels to fill the first vacant cell with a first cell containing the symbol displayed therein, and detect if a third cluster of cells aligned to form a new winning combination.

These and other objects, advantages, purposes and features of the present invention will become apparent upon review of the following specification in conjunction with the drawings. The following drawings form part of the present specification and are included to further demonstrate certain aspects of the present invention. The invention may be better understood by reference to one or more of these drawings in combination with the detailed description of specific embodiments presented herein.

### BRIEF DESCRIPTION OF THE DRAWINGS

The drawings are not necessarily to scale and, in some instances, proportions have been exaggerated in order to more clearly depict certain features of the invention.

FIG. 1 is a perspective view of a gaming machine, according to an embodiment of the present invention;

FIG. 2 is a schematic view of a game system, according to an embodiment of the present invention;

FIG. 3 is an image of an exemplary game window or screen of a wagering game displayed on the gaming machine of FIG. 1, in accordance with an embodiment of the present invention;

FIG. 4 is a representation of objects or symbols of nine different levels intended to populate the game window of FIG. 3, in accordance with an embodiment of the present invention;

FIG. 5 is a schematic representation of the symbols populating the game window, in accordance with an embodiment of the present invention;

FIGS. 6A-6C are schematic representations of a winning combination, in accordance with an embodiment of the present invention;

FIG. 7 is a schematic representation of a merger of the winning combination illustrated in FIG. 6A, in accordance with an embodiment of the present invention;

FIG. 8 is a schematic representation of a vertical movement of one or more reels of the wagering game to refill one or more vacant cells formed due to the merger of the winning combination, in accordance with an embodiment of the present invention;

FIG. 9 is a schematic representation of a movement of the one or more reels to re-populate a gap in the one or more reels created due to the vertical movement of the one or more reels to refill the one or more vacant cells, in accordance with an embodiment of the present invention; and

FIG. 10 is a flow chart for an algorithm that corresponds to instructions executed by a game engine of the game system of FIG. 2, according to an embodiment of the present invention.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION OF PREFERRED EMBODIMENTS

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Throughout this disclosure, unless the context dictates otherwise, the word “comprise” or variations such as “comprises” or “comprising,” is understood to mean “includes, but is not limited to” such that other elements that are not explicitly mentioned may also be included. Further, any terms expressed in the singular form herein are meant to also include the plural form and vice versa, unless explicitly stated otherwise. Also, as used herein, the term “a” and/or “an” shall mean “one or more,” even though the phrase “one or more” is also used herein, the words “and” and “or” shall be both conjunctive and disjunctive, the word “all” means “any and all”, the word “any” means “any and all”, and the word “including” means “including without limitation.”

For purposes of the present detailed description, the terms “wagering game,” “casino wagering game,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game involves wagers of real money, as found with typical land-based or online casino games. In other embodiments, the wagering game additionally, or alternatively, involves wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

While the embodiments described below are directed to a primary wagering game, it should be appreciated that the present disclosure may additionally or alternatively be employed in association with a secondary game. Moreover, while the player's credit balance, the player's wager, and any awards are displayed as an amount of monetary credits or currency in certain of the embodiments described below, one or more of such player's credit balance, such player's wager, and any awards provided to such a player may be for non-monetary credits, promotional credits, and/or player tracking points or credits.

Embodiments of the present invention comprise an innovative application of data processing steps that, when implemented by game-logic circuitry, direct an electronic display device to present a symbol-value aggregation process that minimizes processing overhead by utilizing simple value-bearing symbols forming winning combinations in a straightforward manner. Further, the process aggregates value of the winning combinations according to stored, variable criteria resulting in fewer rules needed for the aggregation process than would be necessary for calculating values of winning symbol combinations enumerated in stored pay tables, as found in prior art reel-spinning routines. At the same time, embodiments of the present invention provide a straightforward visual presentation that is simple to understand and, therefore, effective in generating player excitement and enthusiasm.

In the following, a more detailed description of exemplarily embodiments of the present disclosure will be provided. The game system of the present disclosure, which may also be referred to herein as the “gaming system,” introduces a dynamic element to the game of slots, where the combination of symbols not only yields a win but also triggers the creation of new symbols, potentially leading to further combinations and increased value of payouts or winnings.

As with conventional slot games, paylines provided by the gaming system consist of a series of winning combinations that a player can find across the slot's rows and columns. However, the distinguishing feature of the gaming system of the present disclosure is that, when the player receives a winning combination of objects or symbols, the player not only receives points or winnings from the winning combination but the objects or symbols of the winning combination merge and turn into more valuable objects providing the player an opportunity to strike yet another winning combination having a higher value, which is based on the winning combination of the more valuable objects. Thus, the novel feature of the gaming system is that, when the symbols are aligned into a winning combination or cluster, there is not only a win but also a formation of new and more valuable symbols that replace the winning combination, which may further lead to yet another combination and an increased value of winnings as a result. It should be noted that the formation of new and more valuable symbols that replace the winning combination occurs automatically by the gaming system without the need for the player to spin the reels, as will be described in more detail below.

More specifically, the gaming system of the present disclosure provides for a slot-style game (the “wagering game”) with cluster mechanics and symbols, which when joined together in a predefined sequence or cluster are configured to merge and form new, more precious or higher-value symbols. Therefore, the aim of a player is not only to get as many combinations or clusters as possible, but also to increase the cost, tier, or level of the collected symbols to maximize the winnings.

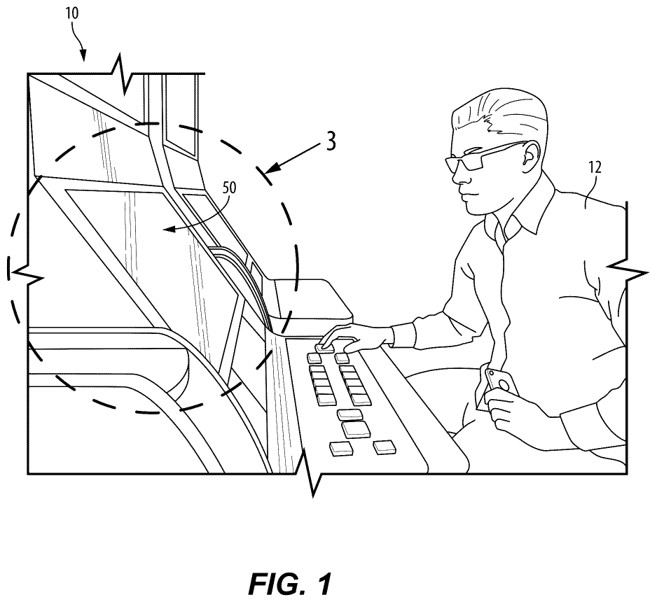

Referring to FIG. 1, there is shown a gaming machine 10 similar to those operated in gaming establishments, such as casinos, that can be used to play the wagering game of the present disclosure by a player 12. The gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game. The gaming machine 10 may take any suitable form, such as a floor-standing model, a handheld mobile unit, a bartop model, a workstation-type console model, etc. Further, the gaming machine 10 may be primarily dedicated for use in playing wagering games, or may include non-dedicated devices, such as mobile phones, personal digital assistants, personal computers, etc.

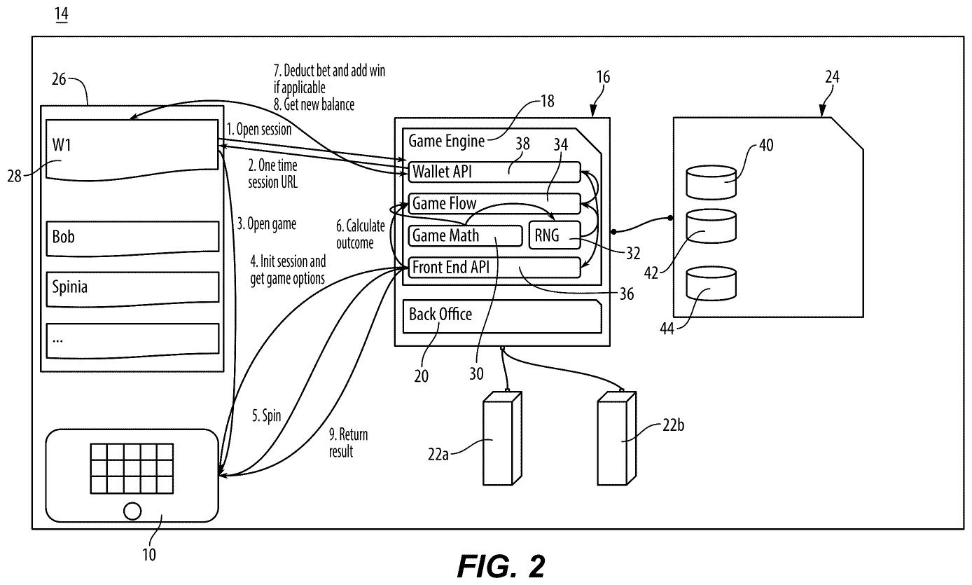

Turning now to FIG. 2, according to an embodiment of the present disclosure, there is shown a block diagram of a game system 14 configured to implement the wagering game of the present disclosure. The game system 14 includes a game application server 16 that comprises a game engine 18 and a back-office module 20. The game application server 16 is run on/supported by and communicatively connected with a pair of physical application servers 22a, 22b. The game system 14 further includes a database 24, a casino 26, and the gaming machine 10 all communicatively connected to the game application server 16. It should be understood that the casino 26 can alternatively be an aggregator, which can be any platform capable of collecting information or content from multiple sources, and that the casino 26 includes “WalletOne” (W1) 28 or any other suitable server, online payment system, e-wallet or payment service.

With continued reference to FIG. 2, the game engine 18 of the game application server 16 includes a game logic module 30, a Random Number Generator (RNG) 32, a game flow management layer 34, a front-end API module 36 for managing communications with the gaming machine 10, and a wallet API module 38 for managing communications with the casino 26. It is envisioned that the database 24 is PostgreSQL—a database system that allows to store and query data using SQL (Structured Query Language)—that comprises a main database server 40, a secondary server 42, and Redis 44 as key-value storage.

Continuing with reference to FIG. 2, for the game system 14 to execute the wagering game of the present disclosure, the game system 14 is configured to operate in a number of steps provided in the description that follows. The casino 26 initiates an “open session” query by requesting the wagering game and transmitting data about the player 12 to the wallet API module 38. The game engine 18 creates a “one time session URL” and returns the session URL to the casino 26. The casino 26 redirects the player 12 to the session URL and the wagering game receives appropriate settings from the game application server 16 and is loaded onto the gaming machine 10 of the player 12. Once the wagering game is loaded, the player 12 is prompted to deposit a balance and make a bet to begin the wagering game, results of which are calculated by the game logic module 30 and the RNG 32 and provided as an output for an http response. Once the player 12 begins the wagering game, wallet API 38 is configured to send a request to the W1 28 to deduct the bet from the balance of the player 12. If the player 12 wins, the wallet API 38 is configured to transmit an amount won by the player 12 to the W1 28 for the amount to be added to the balance of the player 12. In return, the wallet API module 38 is configured to receive the balance of the player 12 from the W1 28. The balance is then transmitted by the wallet API module 38 to the flow management layer 34, which is configured to transmit via http response the balance and other relevant data to the front-end API module 36 for further transmission or communication to the gaming machine 10 of the player 12.

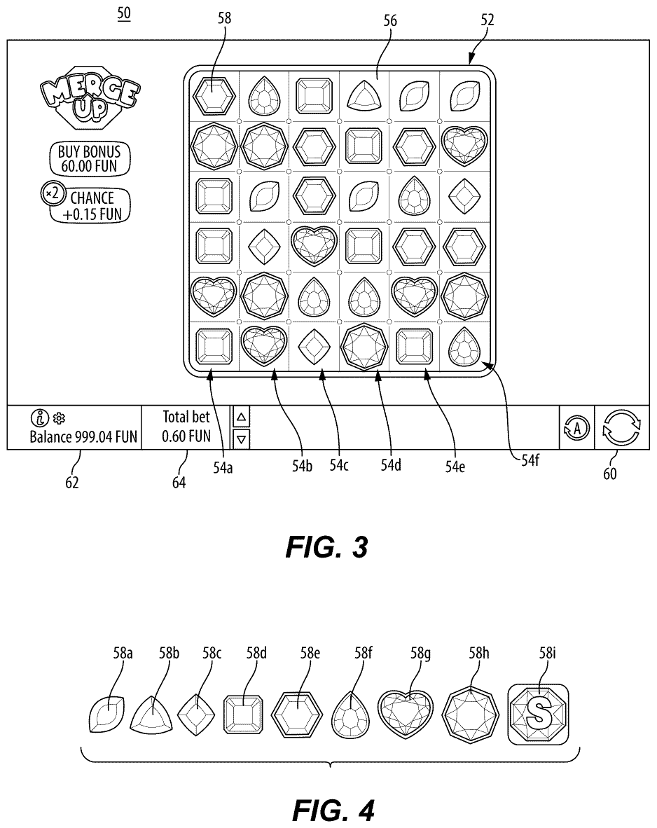

With reference to FIG. 3, there is illustrated an exemplary game window 50 of the gaming machine 10. As illustrated, the game window 50 includes a display game board or symbol field 52 that has a 6×6 matrix having six reels or columns 54a-f, which can be virtual or digital reels, each with six generally square cells 56. It should be understood that there are thirty-six (36) cells 56 within the symbol field 52, and each cell 56 includes a symbol 58, such as for example a precious stone. According to an embodiment of the present disclosure, as shown in FIG. 4, the wagering game of the game system 14 provides nine (9) levels or tiers of symbols 58a-i, each level including a different value symbol, such as a precious stone of a different value. It should be understood that each symbol 58 of a subsequent level has a higher value compared to the symbol 58 of the preceding level. For example, symbol 58b, which is a second tier of value, is more valuable than symbol 58a (first level), and symbol 58c, which is a third tier of value, is more valuable than the symbol 58b (second level), and so on. As discussed above, clustering or forming a winning pattern of more valuable symbols leads to increased winnings or payouts for the player 12. Note that the symbol 58i serves the function of a “scatter” symbol.

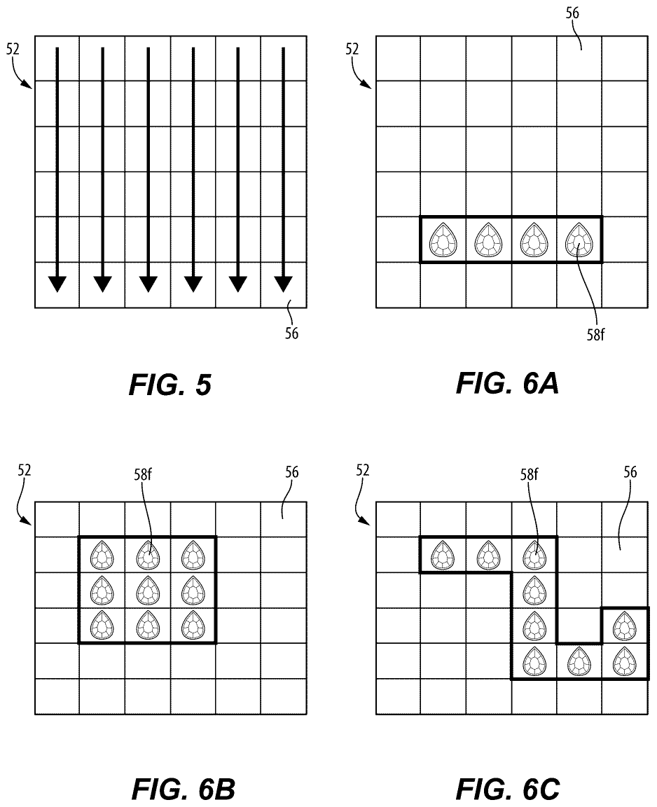

When the player 12 makes the bet to begin the wagering game and the symbol field 52 is activated, one of the symbols 58a-i fill or populate respective one of the cells 56 of the symbol field 52, as shown in FIG. 3. It should be noted that the reels 54a-f each bearing six of the symbols 58a-i roll down, drop, or otherwise appear within the symbol field 52, for example as shown in FIG. 5. According to an embodiment, any six of the symbols 58a-i populate or fill the six reels 54a-f according to two different methods for symbol generation, as will be described in more detail below. If no winning combination was formed, as shown for example in FIG. 3, the player 12 can click a spin button 60 (FIG. 3) to refresh the symbol field 52 such that new symbols 58a-i fill or populate the symbol field 52. When the symbol field 52 produces identical symbols having a symbol arrangement that aligns with one of the winning combinations, patterns, clusters, or paylines, the player 12 earns points, winnings, or credits, which can be found in the balance display 62, as shown in FIG. 3. It should be appreciated that the value of each wager per spin is provided in a total bet window 64, as shown in FIG. 3.

As briefly discussed above, there are two ways envisioned within the scope of the present disclosure to populate or generate the symbols 58a-i on the reels 54a-f. The first is a “fixed reel” method and the second is a “random reel” method. The fixed reel method involves each of the reels 54a-f having randomly prepopulated symbols 58a-i along its length and the game engine 18 is configured to generate a random stop position for each of the reels 54a-f when they are spun, rotated or downwardly moved. For example, when the reel 54a is randomly stopped by the game engine 18 at a certain position, the game window 50 will display, for instance, symbols 58h, 58e, 58g, 58h, 58h and 58g that are fixed on the reel 54a. The random reel method executed by the game engine 18 involves having symbols 58a-i populate or appear on each of the reels 54a-f according to a “weight of symbols” parameter and a “weight of stacks” parameter, which include having each reel 54a-f containing symbol weights according to a probability distribution. For example, each symbol 58a-i has its own weight (30, 90, 10 . . . ) and the sum of all weights is 577. The probability of each symbol with weight W is equal to W/sum. Thus, the sum of all probabilities is 1. It is also envisioned that the wagering game of the present disclosure includes a tumbling feature by which new symbols, falling into the place of the symbols that disappeared, appear according either to the fixed reel method, described in detail below, or the random reel method.

According to an embodiment of the present disclosure, a winning combination is formed as a cluster of at least four (4) cells 56, each cell 56 sharing at least one side with another cell 56 in sequence or series and including an identical symbol 58 therein, such as shown in FIG. 6a. For instance, four identical symbols, as an example 58f, appearing in adjacent cells 56 horizontally, as shown in FIG. 6a, form a winning combination. In turn, identical symbols, for example four symbols 58f, appearing in adjacent cells 56 diagonally do not form a winning combination since the cells do not share at least one side. It should also be appreciated that a layout or pattern of at least four identical symbols 58 appearing in series plays no role in determining a winning combination, as can be seen in FIGS. 6a and 6b, as long as the cluster of at least four cells 56 appear in series and share at least one side with one another. For example, the cluster of nine identical symbols, for example 58f, illustrated in FIG. 6b results in the same payout as the cluster of nine symbols 58f illustrated in FIG. 6c. It should be appreciated that the payout or reward depends directly on the size of the cluster that formed a winning combination and the value of the symbols that formed the winning combination.

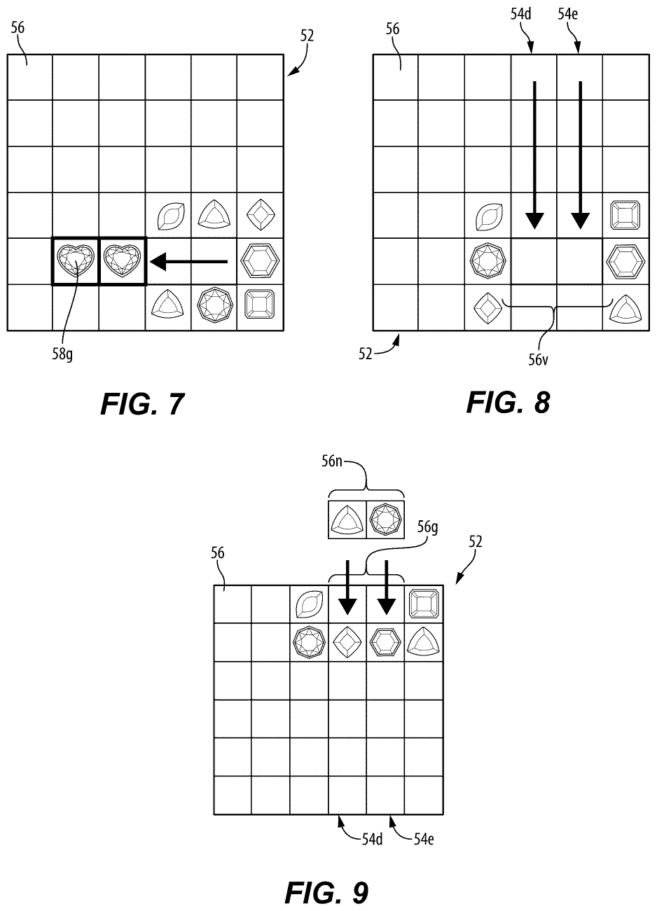

According to an embodiment of the present disclosure, once the wagering game produces a winning combination on the symbol field 52, the identical symbols 58 that have formed the winning combination disappear and merge to form less symbols 58 of a higher level. For example, four symbols 58f appearing in series horizontally, as shown in FIG. 6a, form a winning combination causing the four symbols 58f to disappear and merge, as shown in FIG. 7, into only two symbols 58g, which are the symbols of the next level. It should be noted that the newly-appeared symbols of the next level (e.g. symbols 58g) turn up in random cells of the cluster that formed the winning combination. It should be further noted that if a new winning combination is formed as a result of the newly-appeared symbols of the next level, the winning combination is paid out to the player 12 and the payout is higher since the symbols forming the new winning combination are of higher value. It is also contemplated within the scope of the present disclosure that a winning combination of four or five identical symbols merge into two symbols of the subsequent higher level. Meanwhile, a winning combination of six or more identical symbols merge into three symbols of the subsequent higher level.

Turning now to FIG. 8 and continuing to use the winning combination of the four identical symbols 58f as an example, after the four identical symbols 58f that have formed the winning combination disappeared and merged into the two symbols 58g of the subsequent level, a two-cell vacancy 56v on the symbol field 52 has now been created. The wagering game of the present disclosure is further configured to re-fill or supersede the two-cell vacancy 56v on the symbol field 12. To re-fill the vacancy 56v, the wagering game is configured to lower or drop respective two of the symbols 58 from the cells 56 immediately above the two-cell vacancy 56v, as shown in FIG. 8. To achieve that, respective reels, for example reels 54d and 54e, are rolled down or lowered to re-fill the two-cell vacancy 56v. It should be appreciated that when reels 54d and 54e are dropped or lowered to re-fill the two-cell vacancy 56v, a two-cell gap 56g is formed at the top of the reels 54d and 54e of the symbol field 52, as shown in FIG. 9.

Consequently, with reference to FIG. 9, a new two-cell block 56n, each cell 56 of which containing the symbol 58 either via the fixed reel method or the random reel method, is inserted by the game engine 18 at the top of the reels 54d and 54e of the symbol field 52 to re-fill the two-cell gap 56g and the symbol field 52. In other words, the symbols 58 along the reels 54d and 54e that have been automatically lowered by the game engine 18 to supersede or supplant the two-cell vacancy 56v are automatically re-populated by the game engine 18 at the top of the reels 54d and 54e of the symbol field 52. It should be appreciated that if a new winning combination is formed as a result of the re-fill, the player 12 received yet another payout, and the wagering game is configured to merge the symbols forming the new winning combination and again re-fill the symbol field 52 in the manner described above.

Within the scope and spirit of the present disclosure, it should be appreciated that the mode of merging, lowering, and re-populating symbols when the winning combination is formed of six or more identical symbols is substantially similar to the mode described above for when the winning combination is formed of four or five identical symbols, except that 56v, 56g and 56n are three-cell blocks. A spin cycle described with reference to FIGS. 6a, 7, 8 and 9 continue until there are no winning combinations left on the symbol field 52, as shown in FIG. 3. It will be noted that if there are several winning clusters in one spin, they pay out the winnings in turn, in each of them some of the symbols disappear, and some move to the next level, depending on the symbol.

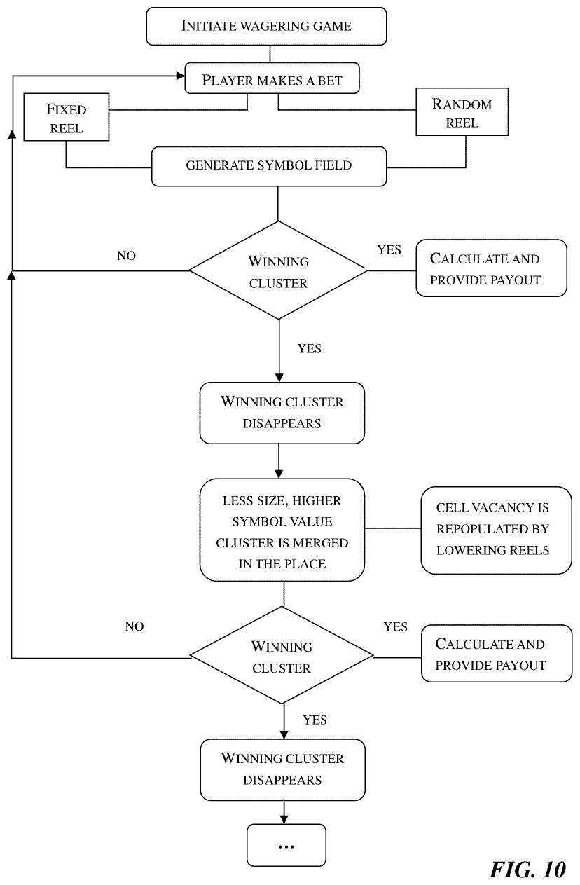

Referring now to FIG. 10, there is shown a flowchart representing a data processing method 100 corresponding to at least some instructions stored and executed by the game engine 18 (FIG. 2) to perform operations according to an embodiment of the present disclosure. At step 102, the engine 18 initiates the wagering game. At step 104, the player 12 is prompted to make a bet using the game window 50. Once the bet is made, the game engine 18 is configured to either automatically/randomly or selectively use the fixed reel method (at step 106a) or the random reel method (at step 106b) to generate, at step 108, the symbol field 52 having the symbols 58a-i appearing on the reels 54a-f. At step 110, the game engine 18 is configured to determine if there is a winning combination.

If no winning combination resulted from the symbol field 52, the player 12 is prompted to make another bet to regenerate the symbol field 52, which again is regenerated or repopulated either via the fixed reel method (at step 106a) or the random reel method (at step 106b). If a winning combination resulted, at step 112, the game engine 18 is configured to calculate and provide a payout to the player 12, and the game engine 18 is further configured, at step 114, to have the winning combination disappear. At step 116, the game engine 18 is configured to merge, in the cells previously occupied by the winning combination, the disappeared symbols of the winning combination into a smaller cluster of one-level higher symbols, which results in a cell vacancy. At step 118, the cell vacancy is repopulated by lowering/dropping respective reels. At step 120, the game engine 18 is configured to determine if there is a winning combination.

If no winning combination resulted, the player 12 is prompted to make yet another bet to regenerate the symbol field 52, which again is regenerated or repopulated either via the fixed reel method (at step 106a) or the random reel method (at step 106b). If a winning combination resulted, at step 122, the game engine 18 is configured to calculate and provide a payout to the player 12, and the game engine 18 is further configured, at step 124, to have the winning combination disappear thereby repeating the steps described above.

As mentioned above, the gaming system provides for nine levels of the symbols 58, as well as bonus features traditional for slots, like Scatter symbols and Free Spins. In the Free Spins, the cells 56 that participate in more than one winning cluster obtain a multiplier that increases with every new win and can achieve×128. The symbol 58 of the last, nineth level is a Scatter, which is the symbol 58i (FIG. 4). The ratio of the number of symbols in a winning cluster to the number of appearing symbols is not constant. The win amount depends on the level of merging symbols and the number of symbols forming a winning combination. The symbol 58i (Scatter) can appear in any position on the symbol field 52. Four or more Scatter symbols 58i trigger a round of Free Spins. Scatter symbol 58i can also appear on the reels 54 when a cluster is formed of the symbols of the highest 8th level. In this case the winning is paid, and the cluster forms one Scatter symbol 58i.

The round of Free Spins is triggered by four or more Scatter symbols. Four Scatters give 15 free spins, Five Scatters—18 free spins, and six or more Scatters—20 free spins. In Free Spins, the cells 56 where a winning cluster was formed are marked. If a marked cell 56 participates in a winning cluster once again, it obtains a ×2 multiplier. In this way, the multiplier of the marked cell increases by ×2 with every new win. A multiplier is applied to a winning combination it participates in, but the newly obtained multiplier will apply only to the next winning combination it will participate in. Several multipliers in one cluster are added. The maximum multiplier in one cell is ×128. The cells remain marked till the end of the round. If during the round four or more Scatters appear on the reels in one spin, the feature is re-triggered. In this case, four Scatters give 5 free spins, five Scatters—8 free spins, and six or more Scatters—10 free spins.

The player can buy a round of Free Spins, according to an embodiment of the present disclosure. If the player 12 changes the wager or bet, the buy bonus price is changed automatically. If the player 12 changes the bet in the pop-up of the Buy Bonus feature, the bet in the main game is also changed automatically. The next spin after the purchase triggers the bonus game. The feature is disabled if the Chance ×2 feature is active. According to an embodiment of the present disclosure, there is a possibility to purchase the Chance ×2 feature. It slightly increases the bet and gives the player 12 more chances to hit Free Spins. The feature is disabled if the Buy Bonus feature is active.

The system and method of the present disclosure provide gaming features and mechanics that raise the probability of forming new winning combinations, having higher payouts, and having increased chances of winning for players, and thus provide an enhanced entertainment value and experience for the players of slot-like video games.

Changes and modifications in the specifically described embodiments may be carried out without departing from the principles of the present invention, which is intended to be limited only by the scope of the appended claims, as interpreted according to the principles of patent law including the doctrine of equivalents.

1. A game system for conducting a game, the game system comprising:
a gaming machine communicatively connected to a game engine, the gaming machine including a user interface (UI) operable by a player, the game engine comprising a game logic module, a random number generator, and a game flow management layer, the game engine configured to:
control the UI to display a symbol field comprising a plurality of reels, each reel including a plurality of cells each containing a symbol displayed therein, wherein each of the symbols has a predefined value or tier assigned thereto;
in response to a first cluster of cells aligning to form a winning combination, identify the winning combination and provide a payout to the player, each cell of the first cluster containing a first symbol, and each of the first symbols being a symbol of an identical value or tier;
in response to the winning combination being identified, cause the first cluster of cells to merge into a second cluster of cells, each cell of the second cluster containing a second symbol, the second cluster having less cells than the first cluster, and each of the second symbols being one level higher in value than the first symbol;
in response to the second cluster having less cells than the first cluster, identify a first vacant cell in the symbol field and lower respective one of the reels to fill the first vacant cell with a first cell containing the symbol displayed therein; and
detect if a third cluster of cells aligned to form a new winning combination.

2. The game system of claim 1, wherein the first cell of the respective one of the reels is positioned in the symbol field immediately above the first vacant cell.

3. The game system of claim 1, wherein the game engine is configured to:
in response to the respective one of the reels being lowered, detect a second vacant cell atop of the respective one of the reels; and
fill or populate the second vacant cell with a second cell containing the symbol displayed therein.

4. The game system of claim 3, wherein the symbol for the second cell is selected via a fixed reel method based on the symbols being fixed on the respective one of the reels or a random reel method based on a probability distribution.

5. The game system of claim 1, wherein the first cluster of cells includes at least four cells sharing at least one side with one another.

6. The game system of claim 1, wherein the second cluster of cells includes at least two cells sharing at least one side with one another.

7. The game system of claim 1, wherein each symbol has one of nine tiers of value, and the symbol having a ninth tier of value is a scatter symbol.

8. The game system of claim 1, wherein the game engine further includes a wallet API module for communicating with a client, a front-end API module for communicating with the gaming machine and the game flow management layer, and a back-office module for communicating with a supporting server.

9. A method of operating a gaming machine, the method comprising:
displaying a symbol field comprising a plurality of reels, each reel including a plurality of cells each containing a symbol displayed therein, wherein each of the symbols has a predefined value or tier assigned thereto;
in response to a first cluster of cells aligning to form a winning combination, identifying the winning combination and providing a payout to the player, each cell of the first cluster containing a first symbol, and each of the first symbols being a symbol of an identical value or tier;
in response to the step of identifying the winning combination, causing the first cluster of cells to merge into a second cluster of cells, each cell of the second cluster containing a second symbol, the second cluster having less cells than the first cluster, and each of the second symbols being one level higher in value than the first symbol;
in response to the second cluster having less cells than the first cluster, identifying a first vacant cell in the symbol field and lowering respective one of the reels to fill the first vacant cell with a first cell containing the symbol displayed therein; and
detecting if a third cluster of cells aligned to form a new winning combination.

10. The method of claim 9, wherein the first cell of the respective one of the reels is positioned in the symbol field immediately above the first vacant cell.

11. The method of claim 9 further comprising:
in response to the respective one of the reels being lowered, detecting a second vacant cell atop of the respective one of the reels; and
filling or populating the second vacant cell with a second cell containing the symbol displayed therein.

12. The method of claim 11, wherein the symbol for the second cell is selected via a fixed reel method based on the symbols being fixed on the respective one of the reels or a random reel method based on a probability distribution.

13. The method of claim 9, wherein the first cluster of cells includes at least four cells sharing at least one side with one another.

14. The method of claim 9, wherein the second cluster of cells includes at least two cells sharing at least one side with one another.

15. The method of claim 9, wherein each symbol has one of nine tiers of value, and the symbol having a ninth tier of value is a scatter symbol.

16. A non-transitory computer-readable medium storing instruction that, when executed by a processor, cause the processor to:
control a user interface to display a symbol field comprising a plurality of reels, each reel including a plurality of cells each containing a symbol displayed therein, wherein each of the symbols has a predefined value or tier assigned thereto;
in response to a first cluster of cells aligning to form a winning combination, identify the winning combination and provide a payout to the player, each cell of the first cluster containing a first symbol, and each of the first symbols being a symbol of an identical value or tier;
in response to the winning combination being identified, cause the first cluster of cells to merge into a second cluster of cells, each cell of the second cluster containing a second symbol, the second cluster having less cells than the first cluster, and each of the second symbols being one level higher in value than the first symbol;
in response to the second cluster having less cells than the first cluster, identify a first vacant cell in the symbol field and lower respective one of the reels to fill the first vacant cell with a first cell containing the symbol displayed therein; and
detect if a third cluster of cells aligned to form a new winning combination.

17. The non-transitory computer-readable medium of claim 16, wherein the first cell of the respective one of the reels is positioned in the symbol field immediately above the first vacant cell.

18. The non-transitory computer-readable medium of claim 16, wherein the game engine is configured to:
in response to the respective one of the reels being lowered, detect a second vacant cell atop of the respective one of the reels; and
fill or populate the second vacant cell with a second cell containing the symbol displayed therein.

19. The non-transitory computer-readable medium of claim 16, wherein the first cluster of cells includes at least four cells sharing at least one side with one another.

20. The non-transitory computer-readable medium of claim 16, wherein the second cluster of cells includes at least two cells sharing at least one side with one another.
